(19) United States
(12) Patent Application Publication
(10) Pub. No.: US 2003/0171050 A1
(43) Pub. Date: Sep. 11, 2003

(54) Flame-resistant thread and fabric produced therefrom

(76) Inventors: Hans-Dieter Eichhorn, Weisenheim am Berg (DE); Gunther Wilder, Grosskarlbach (DE); Heinz Berbner, Morlenbach (DE)

Correspondence Address: C Robert Rhodes, Womble Carlyle Sandridge & Rice, 1900 First Union Tower, 300 N Greene Street, Greensboro, NC, 27401, US

(21) Appl. No.: 10/343,066

(22) PCT Filed: Jul. 24, 2001
(86) PCT No.: PCT/EP01/08521

(30) Foreign Application Priority Data
Aug. 2, 2000 (DE) 100 38 030.1

(51) Int. Cl. B32B 27/34; D02G 3/00; B32B 27/36; B32B 9/00

(52) U.S. Cl. 442/301; 428/365; 428/364; 428/395; 428/392

(57) ABSTRACT

The invention relates to a thread for producing fabric, containing a) 5 to 90 wt. % of melamine fibres, b) 5 to 90 wt. % of natural fibres, and c) 0.1 to 30 wt. % of polyamide fibres consisting of polyamide 66, polyamide 6 or mixtures thereof.

### DESCRIPTION

This invention relates to yarn for producing woven fabrics. The yarn comprises

a) from 5 to 90% by weight of melamine fiber,

b) from 5 to 90% by weight of natural fiber and

c) from 0.1 to 30% by weight of polyamide fiber composed of nylon 66 or nylon 6 or blends thereof.

This invention further relates to the use of such yarn for producing woven fabrics, to woven fabrics containing such yarn, to the use of these fabrics for producing workwear, heat protective clothing or welders' protective clothing, flame protective clothing and flame retardant materials for interior decoration of vehicles and spaces at risk from fire and also finally to workwear, heat protective clothing, welders' protective clothing, flame protective clothing and flame retardant materials for interior decoration of vehicles and spaces at risk from fire comprising said fabrics.

Fabric for workwear, heat protective clothing, welders' protective clothing and flame protective clothing and also for flame retardant materials for interior decoration of vehicles and spaces at risk from fire has to meet a number of requirements at one and the same time. It shall ensure reliable and effective protection against heat and open fire and offer good wear comfort, ie, be skin-compatible. This fabric shall also be readily washable and dryable with industrial washing machines and dryers. Since the clothing and materials mentioned are highly stressed in use, the fabric shall be durable and possess good mechanical strength (eg, tensile strength, tear strength). More particularly, it should possess high abrasion resistance, so that it does not wear through even after prolonged use. Worn areas in the fabric destroy the flame and heat protective effect and constitute an appreciable safety risk for the user of the clothing.

Natural fiber such as cotton absorbs perspiration and is comfortable on the skin and so offers good wear comfort, but cotton yarns suffer during washing and drying, especially under industrial conditions. This stress leads to the cotton thread progressively shedding fiber and becoming thinner and thinner over time and so losing its strength. A further disadvantage of cotton is its poor abrasion resistance.

Flame protective fiber such as that based on aramid (eg, Twaron® from AkzoNobel, Kevlar® and Nomex® from DuPont, Technora® from Teijin) exhibit good heat and flame protection, but their wear comfort is poor because of their harshness. More particularly, their abrasion resistance is poor.

EP-A 874 079 discloses heat and flame protective fabrics including a mixture of melamine fiber and aramid fiber.

DE-A 195 23 081 discloses fiber blends comprising from 10 to 90parts by weight of melamine fiber and from 10 to 90 parts by weight of natural fiber and also fabrics produced therefrom.

DE-A 196 17 634 discloses flame retardant fabrics comprising melamine fiber, optionally flame retardant fiber and standard flammability fiber such as wool, cotton, polyamide, polyester and viscose. Nylon 66 and nylon 6 are not mentioned.

EP-A 976 335 discloses fabrics comprising from 10 to 90% by weight of cotton fiber, from 5 to 45% by weight of polyamide or polyester fiber and from 5 to 45% by weight of melamine fiber. Fiber composed of nylon 66 or nylon 6 is not mentioned; polyester fiber is utilized in the examples.

The property profile of these prior art fabrics is unsatisfactory. More particularly, their abrasion resistance is inadequate.

It is an object of the present invention to remedy the disadvantages described. More particularly, it is an object of the present invention to provide yarn from which it is possible to weave fabric having good heat and flame protective characteristics. The yarn and fabric produced therefrom shall offer high wear comfort and be able to withstand industrial washing and drying. The mechanical strength of the yarn and fabric should also be high. More particularly, a high abrasion resistance shall be ensured.

We have found that this object is achieved by the yarn defined at the beginning. The invention further provides for the use of such yarn for producing woven fabric, woven fabric comprising such yarn, the use of this fabric for producing workwear, heat protective clothing, welders' protective clothing, flame protective clothing and flame retardant materials for interior decoration of vehicles and spaces at risk from fire and also finally workwear, heat protective clothing, welders' protective clothing, flame protective clothing and flame retardant materials for interior decoration of vehicles and spaces at risk from fire comprising said fabric.

None of the prior art documents cited discloses or suggests using specifically nylon 66 or nylon 6 in fractions of from 0.1 to 30% by weight as polyamide fiber.

It will be appreciated that components a) to c) add up to 100% by weight.

In a preferred embodiment, the yarn comprises

a) from 30 to 80% by weight of melamine fiber,

b) from 10 to 60% by weight of natural fiber and

c) from 1 to 20% by weight of polyamide fiber.

Melamine Fiber a)

The melamine fiber used according to the invention may be produced for example according to the processes described in EP-A 93 965, DE-A 23 64 091, EP-A 221 330 or EP-A 408 947. Particularly preferred melamine fiber includes as monomeric building block (A) from 90 to 100 mol % of a mixture consisting essentially of from 30 to 100, preferably from 50 to 99, particularly preferably from 85 to 95, especially from 88 to 93, mol % of melamine and from 0 to 70, preferably from 1 to 50, particularly preferably from 5 to 15, especially from 7 to 12, mol % of a substituted melamine I or mixtures of substituted melamines I.

As further monomer building block (B) the particularly preferred melamine fiber contains from 0 to 10, preferably from 0.1 to 9.5, especially from 1 to 5, mol %, based on the total number of moles of monomeric building blocks (A) and (B), of a phenol or of a mixture of phenols.

The particularly preferred melamine fiber is customarily obtainable by reacting components (A) and (B) with formaldehyde or formaldehyde-supplying compounds and subsequent spinning, the molar ratio of melamines to formaldehyde being in the range from 1:1.15 to 1:4.5, preferably in the range from 1:1.8 to 1:3.0.

Useful substituted melamines of the general formula I

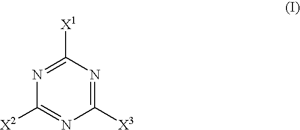

include those where X¹, X² and X³ are each selected from the group consisting of -NH₂, -NHR¹ and -NR¹R², subject to the proviso that X¹, X² and X³ are not all -NH₂, and R¹ and R² are each selected from the group consisting of hydroxy-C₂-C₁₀-alkyl, hydroxy-C₂-C₄-alkyl-(oxa-C₂-C₄-alkyl)ₙ, where n is from 1 to 5, and amino-C₂-C₁₂-alkyl.

Hydroxy-C₂-C₁₀-alkyl is preferably hydroxy-C₂-C₆-alkyl, such as 2-hydroxyethyl, 3-hydroxy-n-propyl, 2-hydroxyisopropyl, 4-hydroxy-n-butyl, 5-hydroxy-n-pentyl, 6-hydroxy-n-hexyl, 3-hydroxy-2,2-dimethylpropyl, preferably hydroxy-C₂-C₄-alkyl, such as 2-hydroxyethyl, 3-hydroxy-n-propyl, 2-hydroxyisopropyl and 4-hydroxy-n-butyl, particularly preferably 2-hydroxyethyl and 2-hydroxyisopropyl.

Hydroxy-C₂-C₄-alkyl-(oxa-C₂-C4-alkyl)ₙ preferably has n from 1 to 4, particularly preferably n 1 or 2, such as 5-hydroxy-3-oxapentyl, 5-hydroxy-3-oxa-2,5-dimethylpentyl, 5-hydroxy-3-oxa-1,4-dimethylpentyl, 5-hydroxy-3-oxa-1,2,4,5-tetramethylpentyl, 8-hydroxy-3,6-dioxaoctyl.

Amino-C₂-C₁₂-alkyl is preferably amino-C₂-C₈-alkyl, such as 2-aminoethyl, 3-aminopropyl, 4-aminobutyl, 5-aminopentyl, 6-aminohexyl, 7-aminoheptyl and 8-aminooctyl, particularly preferably 2-aminoethyl and 6-aminohexyl, very particularly preferably 6-aminohexyl.

Particularly useful substituted melamines for the invention include the following compounds:

2-hydroxyethylamino-substituted melamines such as 2-(2-hydroxyethylamino)-4,6-diamino-1,3,5-triazine, 2,4-di(2-hydroxyethylamino)-6-amino-1,3,5-triazine, 2,4,6-tris(2-hydroxyethylamino)-1,3,5-triazine; 2-hydroxyisopropylamino-substituted melamines, such as 2-(2-hydroxyisopropylamino)-4,6-diamino-1,3,5-triazine, 2,4-di(2-hydroxyisopropylamino)-6-amino-1,3,5-triazine, 2,4,6-tris(2-hydroxyisopropylamino)-1,3,5-triazine; 5-hydroxy-3-oxapentylamino-substituted melamines, 5 such as 2-(5-hydroxy-3-oxapentylamino)-4,6-diamino-1,3,5-triazine, 2,4-di(5-hydroxy-3-oxapentylamino)-6-amino-1,3,5-triazine, 2,4,6-tris(5-hydroxy-3-oxapentylamino)-1,3,5-triazine;

6-aminohexylamino-substituted melamines, such as 2-(6-aminohexylamino)-4,6-diamino-1,3,5-triazine, 2,4-di(6-aminohexylamino)-6-amino-1,3,5-triazine, 2,4,6-tris(6-aminohexylamino)-1,3,5-triazine; or

mixtures thereof, for example a mixture of 10 mol % of 2-(5-hydroxy-3-oxapentylamino)-4,6-diamino-1,3,5-triazine, 50 mol % of 2,4-di(5-hydroxy-3-oxapentylamino)-6-amino-1,3,5-triazine and 40 mol % of 2,4,6-tris(5-hydroxy-3-oxapentylamino)-,1,3,5-triazine.

Useful phenols (B) include phenols that contain one or two hydroxyl groups and may be substituted by radicals selected from the group consisting of C₁-C₆-alkyl and hydroxyl, and also C₁-C₄-alkanes substituted by two or three phenol groups, di(hydroxyphenyl) sulfones, or mixtures thereof.

Preferred phenols are: phenol, 4-methylphenol, 4-tert-butylphenol, 4-n-octylphenol, 4-n-nonylphenol, pyrocatechol, resorcinol, hydroquinone, 2,2-bis(4-hydroxyphenyl)propane, bis(4-hydroxyphenyl) sulfone, particularly preferably phenol, resorcinol and 2,2-bis(4-hydroxyphenyl)propane.

Formaldehyde is generally used as an aqueous solution having a concentration of, for example, from 40 to 50% by weight or in the form of compounds supplying formaldehyde in the course of the reaction with (A) and (B), for example as oligomeric or polymeric formaldehyde in solid form such as paraformaldehyde, 1,3,5-trioxane or 1,3,5,7-tetroxocane.

The particularly preferred melamine fiber is customarily produced by polycondensing melamine, optionally substituted melamine and optionally phenol together with formaldehyde or formaldehyde-supplying compounds. All the components may be added from the start or may be reacted a little at a time and successively and the precondensates formed may have further melamine, substituted melamine or phenol added to them subsequently.

The polycondensation is carried out in a conventional manner (see EP-A 355 760, Houben-Weyl, Vol. 14/2, p. 357 ff).

The reaction temperature is generally in the range from 20 to 150° C., preferably in the range from 40 to 140° C. The reaction pressure is generally not critical. The reaction is generally carried out in the range from 100 to 500 kPa, preferably under atmospheric pressure.

The reaction can be carried out with or without solvent. Generally, no solvent is added when using aqueous formaldehyde solution. When formaldehyde bound in solid form is used, it is customary to use water as solvent, the amount used being generally within the range from 5 to 40%, preferably from 15 to 20%, by weight based on the total amount of monomers used.

The polycondensation is generally carried out in the pH range above 7. The pH range from 7.5 to 10.0 is preferred and that from 8 to 9 is particularly preferred.

The reaction mixture, may further include small amounts of customary additives, such as alkali metal sulfites, eg. sodium disulfite and sodium sulfite, alkali metal formates, eg. sodium formate, alkali metal citrates, eg. sodium citrate, phosphates, polyphosphates, urea, dicyandiamide or dicyanamide. They may be added as pure individual compounds or as mixtures with each other, in each case without a solvent or as aqueous solution, before, during or after the condensation reaction.

Other modifiers are amines and aminoalcohols, such as diethylamine, ethanolamine, diethanolamine or 2-diethylaminoethanol.

Useful additives further include fillers and emulsifiers. Useful fillers include for example fibrous or pulverulent inorganic reinforcing agents or fillers, such as glass fiber, metal powder, metal salts or silicates, for example kaolin, talc, baryte, quartz or chalk, pigments and dyes. Emulsifiers used are generally the customary nonionic, anionic or cationic organic compounds having long-chain alkyl moieties.

The polycondensation can be carried out batchwise or continuously, for example in an extruder (see EP-A 355 760), according to conventional methods.

To produce fiber the melamine resin of the invention is generally spun in a conventional manner, for example after addition of a curing agent, customarily acids, such as formic acid, sulfuric acid or ammonium chloride, at room temperature in a rotospinning machine and subsequently curing the crude fiber in a heated atmosphere or by spinning in a heated atmosphere, simultaneously evaporating the water solvent and curing the condensate. Such a process is described in detail in DE-A-23 64 091.

However, melamine fiber can also be produced using other customary methods, for example fiber pulling, extrusion and fibrillation. The fiber obtained is generally predried, optionally drawn and then cured at from 120to 250° C.

The fiber is typically from 5 to 25 μm in thickness and from 2 to 2000 mm in length.

Useful melamine resins are, for example, commercially available from BASF as Basofil®.

Natural Fiber b)

The natural fibers used are generally naturally occurring fibers based on cellulose, such as cotton, wool, linen or silk, which natural fibers shall also comprehend cellulose-based fibers which are of natural origin but have been modified or treated by known and customary processes.

According to German Standard Specification DIN 60001, cotton and wool in particular are natural fibers, cotton belonging to the group of vegetable fibers. German Standard Specification DIN 60004 defines what is meant by the term wool. For the purposes of this invention, wool shall comprehend all coarse and fine animal hairs.

The natural fiber may if necessary be treated with flame retardants, for example reactive phosphorus compounds. Such compounds are commercially available for example as Aflammit®, from Thor-Chemie, Pyrovatex® or Proban®.

A woven fabric is customarily constructed from warp threads and fill threads (warp and fill for short). The yarn of the fill thread may be identical to the yarn of the warp thread, or warp and fill may differ from each other.

The natural fiber of the fill thread may be identical to or different from the natural fiber of the warp thread. For example, the fill thread may include cotton fiber and the warp thread wool fiber, or vice versa, or fill and warp may include cotton fiber. It is particularly preferable for fill and warp to include the same natural fiber. More particularly, fill and warp include cotton fiber in a fraction of 50%, preferably 80%, especially 100%, by weight based on the natural fiber b) or k1).

Accordingly, especially cotton is used alone as natural fiber b).

Polyamide Fiber c)

Useful polyamide fibers include all customary textile fibers composed of polyamides, the polyamides being selected from the group consisting of nylon 66, nylon 6 and blends thereof.

Polyamide fibers are produced from nylon 66 and nylon 6 by melting spinning or extrusion. Subsequently they are stretched hot or cold. Nylon 6 is polycaprolactam and nylon 66 is made up of hexamethylenediamine and adipic acid units. Details concerning polyamide fibers are given in Ullmanns Encyklopädie der Technischen Chemie, vol. 11, 4th edition, p. 315, Verlag Chemie, Weinheim 1978.

Useful polyamide fibers are commercially available for example from BASF, DuPont and Rhodia.

The yarn for the fill thread may be identical to the yarn for the warp thread, or warp and fill may differ from, each other. The polyamide fiber of the fill thread may be identical to or different from the polyamide fiber of the warp thread. For example, the fill may include nylon 6 fiber and the warp nylon 66 fiber, or vice versa.

When a blend of nylon 6 and nylon 66 is used for polyamide fiber c), the nylon 66 fraction is preferably not less than 50%, especially not less than 90%, by weight, based on c), and the fraction missing from 100% by weight will be nylon 6.

In another preferred embodiment, the nylon 6 fraction is 100% by weight, based on c), ie, polyamide fiber c) includes nylon 6 as sole polyamide.

In another, particularly preferred embodiment, the nylon 66 fraction is 100% by weight, based on c), ie, polyamide fiber c) includes nylon 66 as sole polyamide.

The fiber blends from which the yarn is produced may include up to 25%, preferably up to 10%, by weight of customary fillers, especially fillers based on silicates such as mica, and also dyes, pigments, metal powders, delusterants and spinning assistants.

More particularly, the yarn may include antistatic additives in accordance with DIN EN 1149-1.

In a preferred embodiment, electrically conductive filaments are included, especially by twisting, in the fill thread (preferred), the warp thread or fill and warp. When the fabric is then produced, all, but preferably only some, fill threads and/or warp threads may include these conductive filaments. In the last case, it is customary for “normal” fill threads (without these conductive filaments) and fill threads that include these conductive filaments to alternate in a certain order. Particularly preferably every 2 to 20, especially about every 5 to 10, millimeters, the fabric includes one such conductive filament thread in the fill and/or in the warp. An example of a useful conductive filament is the 24 dtex filament F901. It consists essentially of a nylon 6 core and an outer layer incorporating conductive carbon pigments. This filament is preferred and is commercially available, for example as Resistat® grade from BASF.

In another preferred embodiment, antistatic properties are obtained for the fabric by including electrically conductive staple fiber in the fiber blend from which the fill thread (preferred) or the warp thread or fill and warp is produced. An example of such conductive staple fiber is the 5.6 dtex staple fiber F7105, which consists essentially of a conductive carbon core and an outer layer (sheath) of nylon 6. This staple fiber is preferred and commercially available for example as Resistate grade from BASF. The conductive staple fiber is preferably used in amounts of from 0.5 to 5%, in particular from 1 to 2%, by weight based on the overall fiber blend. This staple fiber and the other fibers of the fill thread and/or warp thread are generally used to produce in a conventional manner a homogeneous fiber blend which is customarily spun into yarn. The warp and/or fill threads and/or the fibers they include may be treated in a conventional manner before they are processed into fabrics, for example by prebleaching, dyeing, finishing with textile assistants, hydrophobicizing, etc.

In a particularly preferred embodiment the fill threads of the fabric include

a) from 40 to 65%, preferably from about 50 to 55% by weight of melamine fiber,

b) from 30 to 45%, preferably about 40% by weight of cotton, and

c) from 3to 15%, preferably from about 5 to 10% by weight of polyamide fiber, most preferably composed of nylon 66 as sole polyamide.

The various fiber varieties are customarily preblended as staple and spun by known processes customary in the textile industry into yarns. However, it is also possible to process the fibers into yarns in some other way. Such processes are known to one skilled in the art.

These yarns can then be further processed into a different textile or nontextile fabric, depending on the field of use.

The yarns of the invention preferably have a fineness of from Nm 5 to Nm 70, especially of Nm 20 to Nm 50. The basis weight of the inventive fabrics produced therefrom is preferably from 70 to 900, especially from 120 to 600, particularly preferably from 300 to 500, g/m².

The fabrics of the invention may include a heat, oil, soil and/or moisture resistant finish. The fabric may be impregnated or coated with the finish.

Examples of useful finishes for the invention are layers of metal, for example aluminum, applied on one or both sides. Such metal layers, which are customarily applied in a thickness of for example 5 to 200 μm, preferably 10-100 μm, so that the flexibility of the fabric is not adversely affected, protect against fire, heat, especially radiant heat, soot and extinguishant, for example water and foam or powder extinguishants. Under the European standard EN 1486 metallized fabrics are useful for producing protective suits for specialized firefighting. Metallation is generally effected by subjecting the fabric to a high vacuum metal vapor deposition process (see Ullmanns Enzyklopädie der Technischen Chemie, 3^{rd} edition, vol. 15, p. 276 and references cited therein). It is also possible to adhere thin metal foils to the fabric. Such metal foils generally comprise a polymeric support film which has been coated with a thin film of metal. They preferably include a polymeric support based on polyester. The metallized films are suitable according to German armed forces supply specification TL 8415-0203 for application to the inventive fabric on one or preferably both sides thereof, for example by means of an adhesive or by hot calandering. Such foils are used by various manufacturers for the coating of wovens (eg. Gentex Corp., Carbondale Pa, USA; C.F. Ploucquet GmbH & Co, D-89522 Heidenheim; Darmstädter GmbH, D-46485 Wesel).

It is further possible to produce the wovens of the invention from metallized yarns or fibers. The yarns are preferably coated with aluminum in layer thicknesses within the range of 10-100 μm. The yarns have metal coatings of from 0.01 to 1 μm. Such yarns or fibers are producible for example on the lines of the processes described in DE-B 27 43 768, DE-A 38 10 597 or EP-A 528 192.

Further examples of useful finishes are water-repellant hydrophobic layers applied to the fabric on one or both sides. Such layers preferably comprise polyurethane materials and/or polytetrafluoroethylene materials. Such coatings are already known from the prior art for improving the weather performance of textiles (see Ullmanns Enzyklopädie der Technischen Chemie, 5^{th}edition, vol. A26, p. 306-312, and Lexikon \ddot{fur}Textilveredelung, 1955, p. 211 ff). These coatings can be such that water vapor can diffuse through the layer while they are not significantly penetrated, if at all, by liquid water or similar firefighting products and by combustion products. These coatings are generally adhered or calandered onto the fabric as polymer films.

Further measures to improve the protective performance of the fabrics comprise finishing the fibers or the fabric with water, oil and/or soil resistant compounds (hydrophobic or oleophobic finish). Such compounds are known as textile assistants to the skilled person (cf. Ullmann's Encyclopedia of Industrial Chemistry 5^{th} edition, vol. A26, p. 306-312). Examplels of water-resistant compounds are metal soaps, silicones, organofluorine compounds, for example salts of perfluorinated carboxylic acids, polyacrylic esters of perfluorinated alcohols (see EP-B-366 338 and references cited therein) or tetrafluoroethylene polymers. The two polymers mentioned last in particular are also used as oleophobic finish.

The fabrics of the invention combine good washing and drying characteristics under industrial conditions (minimal fiber shedding) and high mechanical strength with high wear comfort and with good heat and flame protective performance and are notable in particular for good abrasion resistance.

The abrasion resistance of woven fabrics can be determined using various test methods. They are known to one skilled in the art. A customary way to determine abrasion resistance is the Martindale abrasion test: a pad covered with a wool fabric rests on the test fabric under a certain force and is made to describe circular movements. The number of cycles of the pad is increased step by step and before each increase the test fabric is examined for threads which have worn through. The number of cycles per min at which two threads of the test fabric have been worn through is the Martindale abrasion resistance.

Protective clothing customarily has to meet a minimum Martindale abrasion resistance of more than 20,000 cycles per min under a force of 9 kPa.

Details concerning the Martindale abrasion test are given in the EN 530 standard, Method 1 (wool fabric), Martindale.

It is surprising that the fire resistance and drip resistance of fabrics produced from yarn according to the invention is preserved, despite the polyamide fiber content. This was unforeseeable, since polyamides are known to be highly flammable and to form burning drops, ie, be neither fire resistant nor drop resistant. It is therefore surprising that the fabrics of the invention are as fire and drop resistant as fabrics without polyamide content.

### EXAMPLES

Various fiber blends were used to produce differing yarns in a conventional manner by intimately blending the individual fibers and producing a blend fiber yarn from the intimate blend. The yarn count was 40/2 Nm. Each of the yarns was woven up on a loom in a conventional manner to produce a 2/2 twill construction having 36 warp threads per cm and 20 fill threads per cm. For each of the fabrics, warp and fill were made of the same yarn. The basis weight of each of the fabrics was about 210 g/m².

Melamine fiber a) was Basofil® from BASF. Natural fiber b) was cotton. Polyamide fiber c) was a commercially available 1.7 dtext nylon 66 staple fiber 38 mm in length.

The cotton was flameproofed by treating the ready-produced fabric with Aflammite® from Thor-Chemie.

A fiber d) composed of p-aramid (Nomex® from DuPont) and a fiber e) composed of m-aramid (Teclinora® from Teijin) were used for comparison.

Each of the fabrics was subjected to an EN 530 Martindale abrasion test with a force of 9 kPa on the pad. The result is reported in the number of pad cycles per min at which two threads of the fabric have been worn through.

The table summarizes the compositions and properties of the fabrics.

TABLE

| | | | | | | | |
|---|---|---|---|---|---|---|---|
| Example¹⁾ | 1 V | 2 | 3 | 4 V | 5 V | 6 V | 7 V |

Yarn (warp and fill) composed of [parts by weight]

| | | | | | | | |
|---|---|---|---|---|---|---|---|
| Melamine fiber a) | 60 | 55 | 50 | 55 | 50 | 55 | 50 |
| Cotton fiber b) | 40 | 40 | 40 | 40 | 40 | 40 | 40 |
| Nylon 66 fiber c) | — | 5 | 10 | — | — | — | |
| m-Aramid fiber d) | — | — | — | 5 | 10 | — | |
| p-Aramid fiber e) | — | — | — | — | — | 5 | 10 |
| Martindale | 15,000 | 40,000 | 50,000 | 25,000 | 25,000 | 30,000 | 45,000 |
| abrasion test [min⁻¹] | | | | | | | |

¹⁾V for comparison

The examples show that just 5 parts by weight of nylon 66 improved the abrasion resistance of the fabric substantially: 15,000 without PA, 40,000 cyles with 5 parts by weight of nylons 66, Examples 1 V and 2. Raising the PA fraction to 10 parts by weight improves the abrasion resistance to 50,000 cycles.

On departing from the invention and replacing the polyamide by the same amount of m-aramid the abrasion resistance of the fabric deteriorates substantially: in the case of 5 parts each of PA or m-aramid from 40,000 to 25,000 (Examples 2 and 4V), in the case of 10 parts by weight each from 50,000 to 25,000 cycles (Examples 3 and 5V).

On again departing from the invention and replacing the polyamide by the same amount of p-aramid, the abrasion resistance likewise deteriorates: in the case of 5 parts by weight each of PA and p-aramid from 40,000 to 30,000 (Examples 2 and 6V), in the case of 10 parts by weight each from 50,000 to 45,000 cycles (Examples 3 and 7V).

We claim:—

1. Yarn for producing woven fabrics, comprising
a) from 5 to 90% by weight of melamine fiber,
b) from 5 to 90% by weight of natural fiber and
c) from 0.1 to 30% by weight of polyamide fiber composed of nylon 66 or nylon 6 or blends thereof.

2. Yarn as claimed in claim 1, comprising
a) from 30 to 80% by weight of melamine fiber,
b) from 10 to 60% by weight of natural fiber and
c) from 1 to 20% by weight of polyamide fiber.

3. Yarn as claimed in claims 1 to 2, wherein said natural fiber b) is cotton fiber.

4. Yarn as claimed in any of claims 1 to 3, wherein said polyamide fiber c) includes nylon 66 as sole polyamide.

5. The use of yarn as claimed in any of claims 1 to 4 for producing woven fabrics.

6. Woven fabric comprising yarn as claimed in any of claims 1 to 4.

7. The use of woven fabric as claimed in claim 6, for producing workwear, heat protective clothing, welders' protective clothing, flame protective clothing and flame retardant materials for interior decoration of vehicles and spaces at risk from fire.

8. Workwear, heat protective clothing, welders' protective clothing, flame protective clothing and flame retardant materials for interior decoration of vehicles and spaces at risk from fire comprising fabric as claimed in claim 6. A yarn for producing woven fabrics comprises
a) from 5 to 90% by weight of melamine fiber,
b) from 5 to 90% by weight of natural fiber and
c) from 0.1 to 30% by weight of polyamide fiber composed of nylon 66 or nylon 6 or blends thereof.
